(19) United States
(12) Patent Application Publication
(10) Pub. No.: US 2016/0225471 A1
(43) Pub. Date: Aug. 4, 2016

(54) FUNCTIONAL CONDUCTING POLYMERS FOR REDOX MEDIATED SEPARATIONS OF F-ELEMENTS

(71) Applicant: BOARD OF REGENTS, THE UNIVERSITY OF TEXAS SYSTEM, Austin, TX (US)

(72) Inventor: Bradley J. Holliday, Austin, TX (US)

(21) Appl. No.: 14/917,478

(22) PCT Filed: Sep. 9, 2014
(86) PCT No.: PCT/US2014/054839

§ 371 Date: Mar. 8, 2016

Related U.S. Application Data
(60) Provisional application No. 61/875,116, filed on Sep. 9, 2013.

(51) Int. Cl. G21C 19/46; C08G 81/00; G21F 9/12; C08G 75/00

(52) U.S. Cl. CPC G21C 19/46; C08G 75/00; C08G 81/00; G21F 9/125

(57) ABSTRACT

The present invention provides a redox mediated polymer composition for the selective sequestration and separation of multivalent metal ions comprising: 2 or more monomers polymerized to form a polymeric thiophene backbone, wherein each of the 2 or more monomers comprise 2 thiophene portion groups for polymerization and 2 pendant carbomylmethyl-phosphine oxide or diglycolamide groups that sequester selectively the multrivalent metal ions.

### TECHNICAL FIELD OF THE INVENTION

The present invention relates in general to the field of processing and recycling irradiated nuclear fuels, and more particularly, to electroactive polymer membrane functionalized with ionophores for f-element extraction and separation.

### BACKGROUND OF THE INVENTION

Without limiting the scope of the invention, its background is described in connection with electroactive polymer materials functionalized with ionophores for the separation of americium (Am(III) or Am⁺³) from curium (Cm(III) or Cm⁺³) in nuclear waste streams. Nuclear waste reprocessing allows more energy to be produced from nuclear fuel and provides safer long term storage of the spent nuclear fuel. Nuclear fuel is made up primarily of uranium however trace impurities with extremely long half-lives that are created during power generation and result in a decrease in power generation efficiency and posing extreme engineering challenges to safely store. The effective separation of large quantities of nuclear waste for further processing remains a key challenge for today's researchers. Ion exchange resins and column chromatography have shown excellent separation efficiencies for key components of nuclear waste but are not capable of handling the high throughputs required by commercial plants. Alternatively, liquid/liquids extraction processes can handle high throughputs, but suffer from low selectivity, generate large additional volumes of waste, and require additional stripping agents to recover the active separation material. The process currently used for recycling spent nuclear fuel rods involves dissolving the fuel in acidic aqueous media and then, through a series of liquid-liquid extractions, separating different elemental components of the mixture. The liquid-liquid extractions involve biphasic mixtures of organic solvents such as kerosene with the acidic aqueous fuel mixture. The process used to achieve the selective extraction and separation of the components of the mixture utilizes carefully designed chelator molecules that are dissolved in the organic solvent and selectively bind different ions in the fuel mixture. Therefore, it is highly desirable to develop alternative separation systems to bypass these processing issues.

Spent nuclear fuel contains many radioisotopes with half-lives on the order of 10³ years. This makes engineering an effective storage system to contain the material for the life of the radioactivity very difficult. With the advent of fast spectrum reactors many of these long lived products can be transmuted into shorter lived radioisotopes, creating more energy and less high level waste. This however, requires the separation of the various components in the fuel into separate waste streams. This is a difficult task, especially for obtaining selectivity between the lanthanides and actinides when considering the chemical similarities of these two classes of ions.

### SUMMARY OF THE INVENTION

One solution is a process termed partitioning and transmutation, whereby the various elements in the fuel are separated and then buried as less hazardous waste or transmuted into less harmful isotopes. Transmutation, however, requires that those elements with high neutron absorption cross sections first be removed. One of the most difficult processes of these separations involves the partitioning of actinides and lanthanides.

The present invention provides compositions and methods for the separation of americium from curium in nuclear waste streams would greatly reduce the technical burdens for transmutation of these transuranic elements. Current separation processes displaying high efficiencies are based on chromatographic techniques that are difficult to translate into high throughput systems. Furthermore, liquid/liquid extraction systems have shown little selectivity and can generate large amounts of waste during processing. The present invention provides methods for the synthesis of an electroactive polymer membrane functionalized with ionophores offers a novel solution to this problem and provides the selective extraction of Am(III) from a mixture containing Am(III) and Cm(III) along with other elements and ions by the polymer membrane of the present invention and presents an efficient means of separation without increasing the volume of waste. In addition, changes in the systems thermodynamics of ion binding from electrochemical injection of holes into the polymer matrix allows for controlled ion release via electrostatic repulsion. The separation system can then be recovered through reduction of the polymer matrix to its original state. Redox mediated polymer separation systems as described herein has not been demonstrated in the literature to date and is thus novel and nonobvious. The present invention provides the design and synthesis of monomers to create a redox mediated polymer separation system.

The present invention provides bifunctional monomers containing both selective metal ion binding sites and groups that can be easily electropolymerized. Electroactive polymer films of the present invention can been grown from the bifunctional monomers. Results from binding/extraction studies show uptake of the surrogate Th(IV) ion from aqueous solution and subsequent release upon electrochemical oxidation of the polymer film. These present invention provides a polymeric redox mediated ionophore.

The present invention includes a polymeric material with pendant chelator functionalities that serve to efficiently and selectively bind ions in the aqueous media Additionally, this polymeric material is synthesized upon a polymer or copolymer backbone that allows other functional moieties to be incorporated throughout the polymer backbone. The other functional groups can be used to impart important additional properties to the material. In one embodiment the polymeric chelator can be used in a membrane extraction procedure eliminating the need for the organic phase all together.

The present invention provides a conducting polymeric extractant with pendant chelator groups covalently attached to the polymer backbone and selectively binds actinides and/or lanthanides, displays very high extraction efficiency, can achieve extractions in a single phase environment, has a modular design to easily incorporate new/different chelator groups or different monomers with different properties for different applications or improved efficiency.

In its simplest form the present invention provides a polymeric material decorated with chelating groups which can selectively bind metal ions from an aqueous solution. Because this material is based on a pendent group depending from a polymer backbone, different groups can be incorporated to change the efficiency, selectively, and mode of action of the chelating polymer. This material has a wide variety of uses including: chelation therapy, waste water remediation, water purification, and nuclear fuel reprocessing.

The present invention provides polymeric extractant materials formed with monomers having pendent carbamoylmethylphosphine oxide (CMPO) groups and with monomers having pendent diglycolamide (DGA) groups. The invention provides polymeric extractant materials with the addition of new polymeric monomers to influence additional functionalities of the polymeric extractant materials. The present invention provides the ability to selectively partition select actinides and or select lanthanides using both liquid-liquid and solid-liquid extractions. The extraction behaviour of the materials was significantly altered by the incorporation of new monomers.

The present invention provides a redox mediated polymer composition for the selective sequestration and separation of multivalent metal ions comprising: 2 or more monomers polymerized to form a polymeric thiophene backbone, wherein each of the 2 or more monomers comprise a thiophene portion and one or more pendant carbomylmethylphosphine oxide groups that sequester selectively the multivalent metal ions.

The composition further comprising one or more second monomers polymerized with the 2 or more monomers to form a polymeric thiophene backbone, wherein the one or more second monomers comprise one or more pendant diglycolamide (DGA) groups. The multivalent metal ions may be selected from Am³⁺, Cu³⁺, Nd³⁺, and Sm³⁺. The multivalent metal ions may be selected from Nd³⁺, Am³⁺, and Th⁴⁺. The redox mediated polymer composition may be disposed on a porous inert resin, a silica support, a removable electrode or made into a membrane or film.

The polymeric thiophene backbone includes one or more thiophene groups. The 2 or more monomers may include 2 pendant carbomylmethylphosphine oxide groups. The one or more second monomers may include 2 pendant diglycolamide (DGA) groups. The multivalent metal ions may be releasably held by the one or more pendant carbomylmethylphosphine oxide groups.

The present invention provides a process for selective separating multivalent metal ions in the processing of a nuclear fuel comprising the steps of: providing a fluid mixture comprising fission products, lanthanides, actinides, nitric acid and water; providing a redox mediated polymer film for selective sequestration and separation of multivalent metal ions comprising: a polymeric thiophene backbone with one or more pendant carbomylmethylphosphine oxide groups; contacting the fluid mixture with the redox mediated polymer film; reversibly binding a multivalent metal ion to the one or more pendant carbomylmethylphosphine oxide groups of the redox mediated polymer film; and separating the redox mediated polymer film from the fluid mixture, wherein a multivalent metal ion is separated from the fluid mixture. The method may include reducing the redox mediated polymer film to release the multivalent metal ion and recycle the redox mediated polymer film. The method may include one or more pendant diglycolamide (DGA) groups pendent from the polymeric thiophene backbone. The multivalent metal ions are selected from Am³⁺ and Nd³⁺.

The present invention provides a process for making a redox mediated polymer composition for the selective sequestration and separation of multivalent metal ions used in the processing of a nuclear fuel comprising the steps of: providing a CMPO monomer comprising a polymerizable thiophene portion and one or more pendant carbomylmethylphosphine oxide groups; optionally providing a DGA monomer comprising a polymerizable thiophene portion and one or more pendant diglycolamide (DGA) groups; polymerizing the polymerizable thiophene portions to form a redox mediated polymer backbone with pendent carbomylmethylphosphine oxide groups to selectively sequester multivalent metal ions; and optionally diglycolamide (DGA) groups pendent from the redox mediated polymer backbone. The method further comprising the step of forming the redox mediated polymer film into a redox mediated polymer membrane. The CMPO monomer comprises 2 pendant carbomylmethylphosphine oxide groups and the DGA monomer comprises 2 pendant diglycolamide (DGA) groups.

The present invention provides a redox mediated polymer composition for the selective sequestration and separation of multivalent metal ions comprising: 2 or more monomers polymerized to form a polymeric thiophene backbone, wherein each of the 2 or more monomers comprise a first monomer that comprises 2 thiophene portions that polymerize to form a polythiophene backbone and 2 pendant carbomylmethylphosphine oxide groups that pend from the polythiophene backbone to sequester selectively the multivalent metal ions; and optionally a second monomer that comprises 2 thiophene portions that polymerize to form a polythiophene backbone and 2 pendant diglycolamide groups that pend from the polythiophene backbone. The redox mediated polymer composition may be a homopolymer of first monomer or a copolymer of first monomer and the second monomer, and may be a block copolymer, a random copolymer or a random block copolymer.

The present invention provides a redox mediated polymer composition for selective sequestration of ions having the structure:

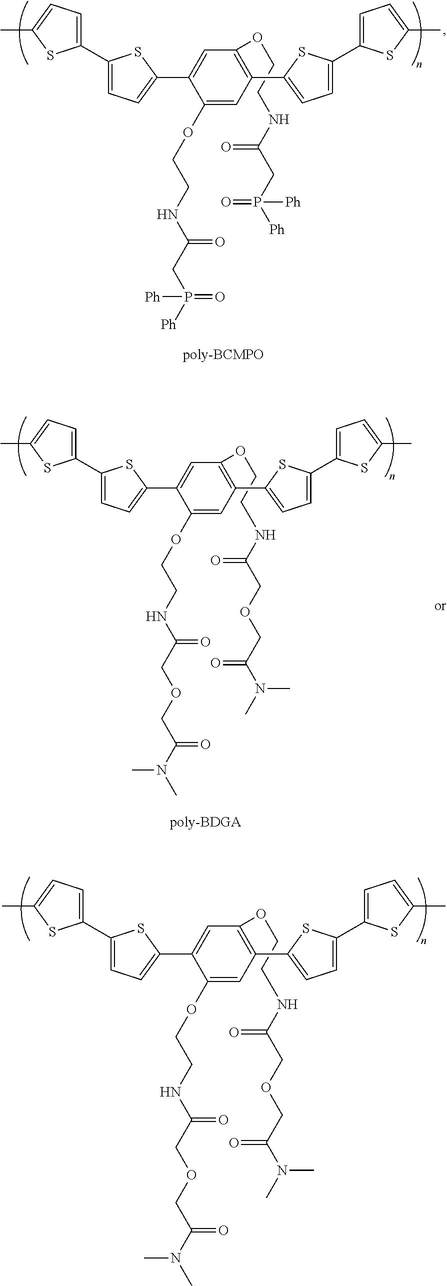

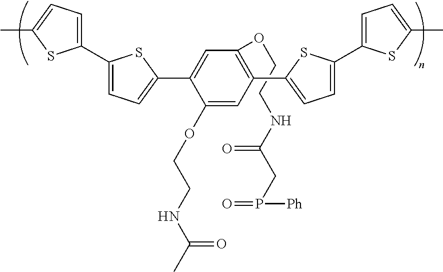

### BRIEF DESCRIPTION OF THE DRAWINGS

For a more complete understanding of the features and advantages of the present invention, reference is now made to the detailed description of the invention along with the accompanying figures and in which:

FIGS. 1a and 1b show the monomer core system used as the platform for the separation materials.

FIG. 2 shows the synthesis of the bithiophene units placed in the para-position to one another on the benzene ring to promote conductivity.

FIG. 3 is a schematic of the separation of americium and curium.

FIG. 4 is a graph that shows the polymer systems can uptake and release ions.

FIG. 5 is a graph of the uptake of Th(IV) over time.

FIG. 6a is an image of the BCMPO structure.

FIG. 6b is an image of the BDGA structure.

FIG. 7a is an image of BCMPO binding Th⁴⁺.

FIG. 7b is an image of BDGA binding Th⁴⁺.

FIG. 8a is an image of a homopolymer of BCMPO.

FIG. 8b is an image of a homopolymer of BDGA.

FIG. 9 is a graph of the separation cycle of the conducting polymer of the present invention over 3 uptake and release cycles.

FIGS. 10a and 10b are images of some of the ligands of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a polymeric material with a polymer backbone and carbamoylmethylphosphine oxide, CMPO and/or diglycolamide DGA, ligand pendant groups. The material of the present invention allows the selective partition of actinides utilizing a redox-mediated extraction strategy. The CMPO-based scheme provides a modular approach that is beneficial for practical implementation allowing easy manipulation of the molecular weight of the polymers and in turn the extraction and separation abilities. These materials may be formed into as modular polymeric scaffolds for the selective extraction of metal ions from aqueous media.

The present invention includes a polymeric material with pendant chelator groups covalently attached to the polymer backbone and that it can be incorporated into a copolymer to modify the chelating properties. The polymers of the present invention may be impregnated into polymer or bead materials which does not show high selectivity and can suffer from leaching of the chelators. The present invention provides a simple, modular, and highly stable polymeric chelator that shows good performance and can be easily varied to optimize the properties. Additionally, the polymeric system has the advantage of easy separation from the aqueous medium and, in the case of nuclear fuel reprocessing, the ability to be used in a single phase extraction scheme.

Demonstrated in the transuranic extraction (TRUEX) process was the ability of the carbomylmethylphosphine oxide (CMPO) ligand to selectively bind to actinides over lanthanides. Reprocessing spent fuel begins with the dissolution of the fuel rods in nitric acid. In the TRUEX process actinides are sequestered from the aqueous acidic media into an organic medium by chelation through the carbonyl and phosphoryl oxygens of three CMPO ligands.

In general, the separation of americium (Am(III)) from curium (Cm(III)) is difficult as they have similar sized ionic radii, are usually found in the +3 oxidation state, have similar softness makes rational design based on Lewis acidity difficult and computational studies have shown no structural basis for the separation of americium from curium. The present invention provides methods for the synthesis of an electroactive polymer membrane functionalized with ionophores for the selective extraction of Am(III) from Cm(III). The polymer membrane of the present invention presents an efficient means of separation without increasing the volume of waste.

The transmutation of americium and curium can be achieved more efficiently and with less handling issues if the two elements are mutually separated from one another. Current systems based on chromatographic techniques may display good efficiencies but suffer from low throughput volumes and liquid-liquid extraction systems may handle large volumes but suffer from low separation efficiencies and generate large volumes of waste. The present invention provides a conductive polymer system with selective ionophores incorporated directly into the polymer for the separation of these transuranic elements. The polymer system separates americium from curium by selectively up taking one ion while leaving the other in solution. The conductive polymer membrane may then be moved to a fresh electrolyte solution and the ions released through columbic and thermodynamic changes induced from electrochemical oxidation of the polymer system. Reduction of the polymer back to the neutral state would then recover the active separation system. The present invention provides for the design and synthesis of monomers an electroactive polymer membrane functionalized with ionophores for the selective extraction of americium from curium. The present invention provides the electropolymerization of monomers and electroactive properties of the corresponding polymers.

The conducting polymer material of the present invention provides unique solutions to the problem of separating americium and curium and reduces the amount of waste generated when compared to liquid-liquid extractions; provides a heterogeneous extraction system that leads to easy recycling of separation membrane, provides an oxidative current flow through the conducting polymer membrane resulting in efficient release of the chelated ions eliminating the need for stripping agents, and provides multiple cycles of the separation process that lead to increased separation efficiency.

The synthesis of an electroactive polymer membrane functionalized with ionophores for the selective extraction of americium from curium as an efficient means of separation without increasing the volume of waste. The ion binding from electrochemical injection of holes into the polymer matrix allows for controlled ion release via electrostatic repulsion. The separation system can then be recovered through reduction of the polymer matrix to its original state. Bifunctional monomers continuing both selective metal ion binding sites and groups that can be easily electropolymerized have been synthesized. Electroactive polymer films have been grown from the monomers and binding/extraction studies show uptake of the surrogate Th(IV) ion from aqueous solution and subsequent release upon electrochemical oxidation of the polymer film. These results represent the first example of a polymeric redox mediated ionophore.

The present invention provides polymeric chelators for metal ion extraction and separation. In some implementations, a polymeric material is decorated with chelating groups that can selectively bind metal ions from an aqueous solution. This material may have, in various situations, a wide variety of uses including: chelation therapy, waste water remediation, water purification, and nuclear fuel reprocessing. In various implementations, chelators are covalently attached to a polymer backbone. The material it can be incorporated into a block copolymer, random polymer or random block copolymer to modify the chelating properties. Although it is discussed in terms of polymers and copolymers the polymer may include 1, 2, 3, 4, 5, 6, 7, 8, 9, monomers or blocks as necessary to achieve the desired properties. The material can also be used independently or in combination with other technologies. Other technologies include those that impregnate chelators into polymer or bead materials. In various implementations, the use of polymer backbones and/or incorporation into block copolymers can improve selectivity and/or avoid leaching of the chelators. In various implementations, the polymeric chelators can be varied to optimize chelating properties. Additionally, the polymeric system can, in some implementations, be easily separated from a fluid medium. In situations such as nuclear fuel reprocessing, some polymeric chelators may enable a single phase extraction scheme.

The present invention provides a process to achieve the selective extraction and separation of the components of the mixture utilizes carefully designed chelator molecules that are dissolved in the organic solvent and selectively bind different ions in the mixture. The present invention provides a polymeric material with pendant chelator functionalities and polymerizable functionalities. These chelator groups can serve to efficiently and selectively bind ions in the aqueous media and transfer these ions to the organic solvent. Additionally, this polymeric material can be synthesized, in some implementations, upon a polymer backbone so other functional moieties may also be incorporated either in separate blocks or randomly throughout the polymer backbone. The other functional groups can be used to impart important additional properties to the material. In one form of the invention, the polymeric chelator can be used in a single phase extraction procedure eliminating the need for the organic phase all together.

The present invention provides a polymeric material with chelator functionalities selectively binds actinides over lanthanides; one actinide ion over another actinide ion; one lanthanides ion over another lanthanides ion or a combination thereof. In various implementations, a polymeric material with chelator functionalities provides high extraction efficiency. In various implementations, a polymeric material with chelator functionalities achieves extractions in a single phase environment and can be synthesized using modular design to easily incorporate new/different chelator groups for different applications or improved efficiency. In various implementations, a polymeric material with chelator functionalities is deployed with a copolymer material to modify properties by incorporating additional monomers with different properties. In various implementations, a polymeric material with chelator functionalities eliminates a need for organic phase in extraction processes. In various implementations, a polymeric material with chelator functionalities provides an increased chelation selectively.

The present invention provides conducting polymer based chelators for redox-mediated metal ion extraction and separation. In various embodiments, these chelator groups serve to efficiently and selectively bind ions from aqueous media into a heterogeneous insoluble polymer film. Subsequently, the redox properties of this conducting polymeric material can be used to exclude the metal ions into a different solution without stripping reagents or salt gradients. In various configurations, the process can be easily cycled. Cycling can, in various situations, exploit modest separation efficiencies to achieve near-complete or complete separation.

The present invention provides an electrically conducting polymeric material with chelator functionalities for high extraction efficiency using polymer-based redox chemistry to exclude metal ions in a heterogeneous extraction scheme for decreasing waste. The electrically conducting polymeric material with chelator functionalities of the present invention enables a modular design for incorporating new/different chelator groups for different applications or improved efficiency and can serve as a chemoresistive sensing platform for metal ions. In addition, the electrically conducting polymeric material with chelator functionalities of the present invention eliminates a need for stripping reagents or salt gradients to expel metal ions.

The present invention provides the synthesis of a polymeric redox mediated ionophore for the separation of nuclear waste using a poly(thiophene) based core onto which derivatives of carbamoylmethylphosphine oxide (CMPO) and diglycolamide (DGA) have been grafted. There is a synergistic effect when derivatives of CMPO and DGA are preorganized onto platform systems leading to higher extraction efficiencies and better separation coefficients. Furthermore, the preorganization of extractants onto heterogeneous support systems is desirable to enhance the ease of recovery of the extractant during processing. However, the usefulness of the poly(thiophene) backbone ultimately lies in its ability to affect the binding constant of the chelated cations.

The present invention provides electropolymerization of the thiophene based core and leads to the deposition of the poly(thiophene) separation material onto the surface of an electrode. This electrode may then be placed into a solution of aqueous nuclear waste where the grafted ionophores will selectively remove certain components of the nuclear waste. Transfer of the electrode to a fresh electrolyte solution and subsequent electrochemical oxidation of the polymer membrane will purge the material of any chelated cations. Facile, easy recovery of the separation material is then realized via reduction of the polymer core to the neutral state in a fresh electrolyte solution.

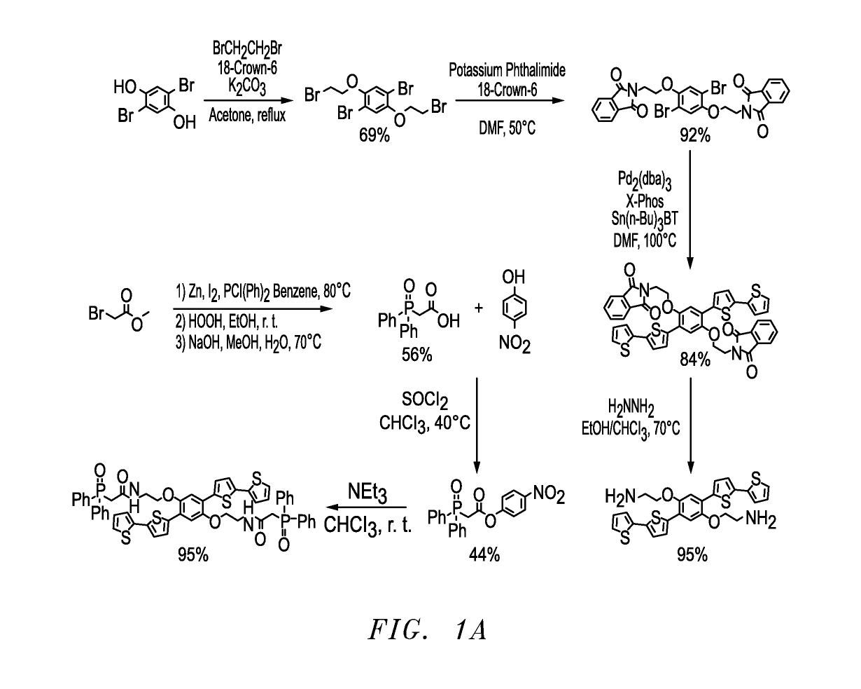

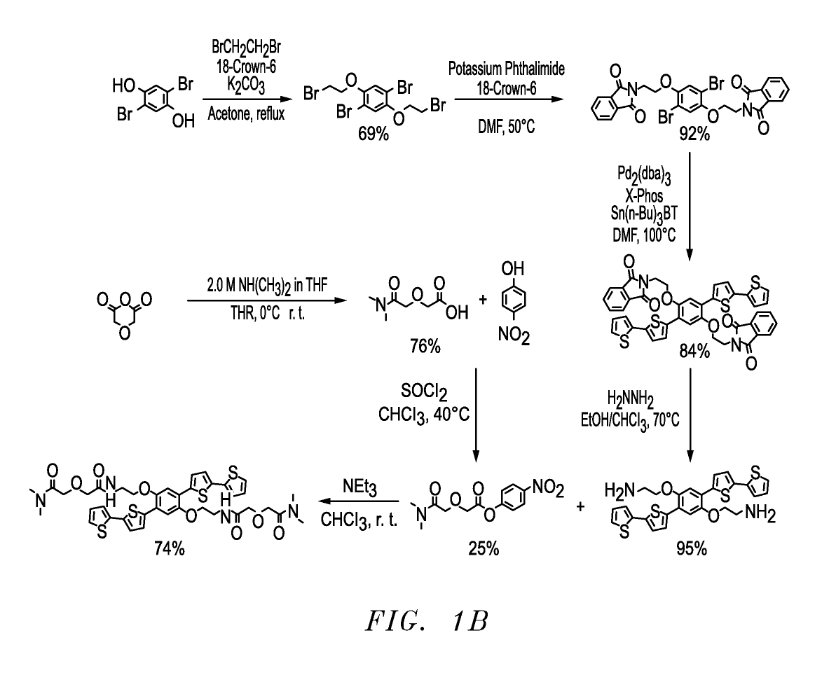

In one embodiment, the monomer core system used as the platform for the separation materials was synthesized as shown in FIGS. 1a and 1b, with FIG. 1a showing the synthesis of BCMPO and FIG. 1b showing the synthesis of BDGA. FIG. 2 shows the synthesis of the bithiophene units placed in the para-position to one another on the benzene ring to promote conductivity. Furthermore, the monomer features ethylamine arms synthetically grafted to the core via ether linkages in order to promote flexibility for coordination while providing a stable attachment for the ionophoric arms as shown.

Monomers of BCMPO and BDGA were both fully characterized by NMR, IR, UV-VIS, mass spectrometery, and elemental analysis and displayed excellent agreement with both expected and literature values (where applicable). Chelation of the monomers to a surrogate actinide, Th(NO₃)₄.XH₂O, was observed via IR. The IR spectra for BDGA shows a single broad peak at 1646 cm⁻¹ corresponding to the carbonyl stretching frequency which, upon introduction to Th(IV), shifts to 1633 cm^{-1.}. Similarly, BCMPO shows strong peaks at 1175 cm⁻¹ and 1667 cm⁻¹ corresponding to the phosphine oxide and carbonyl stretching frequencies, respectively. Chelation to Th(IV) shifts the phosphine oxide peak to 1120 cm⁻¹ and the carbonyl frequency shifts to 1617 cm⁻¹. Electropolymerization of the monomers onto stainless steel yielded polymer films that showed linear growth and linear scan rate dependences up to 500 mV s⁻¹ indicating the polymer have excellent conductivity and high ionic porosity which should allow for the entire polymer system to participate in the extraction and separation processes. Spectroelectrochemistry of the polymer films shows extensive delocalization of the bipolaron further illustrating the highly conductive nature of the polymer systems.

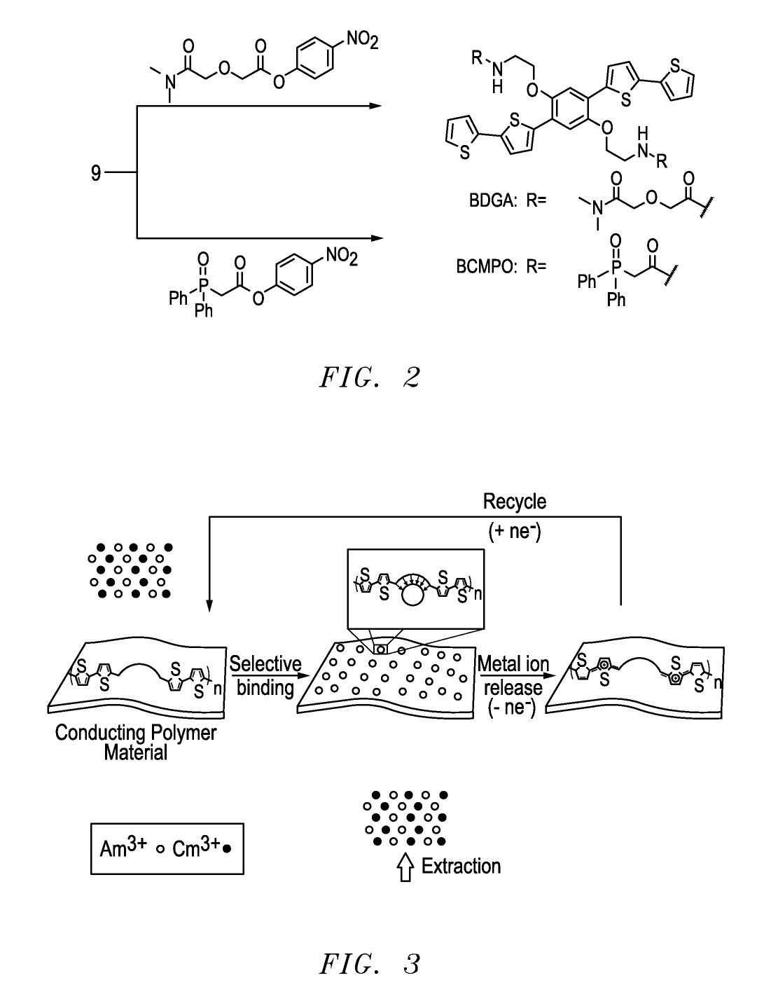

FIG. 3 is a schematic of the separation of americium and curium. The present invention provides a conducting polymer material that selectively binds americium to allow the separation from curium. The americium is bound and retained on the conducting polymer while curium is retained in solution. The conducting polymer with bound americium can then be removed from the solution and recycled by releasing the americium. The conducting polymer material can then be placed in contact with a solution containing both americium and curium to repeat the separation.

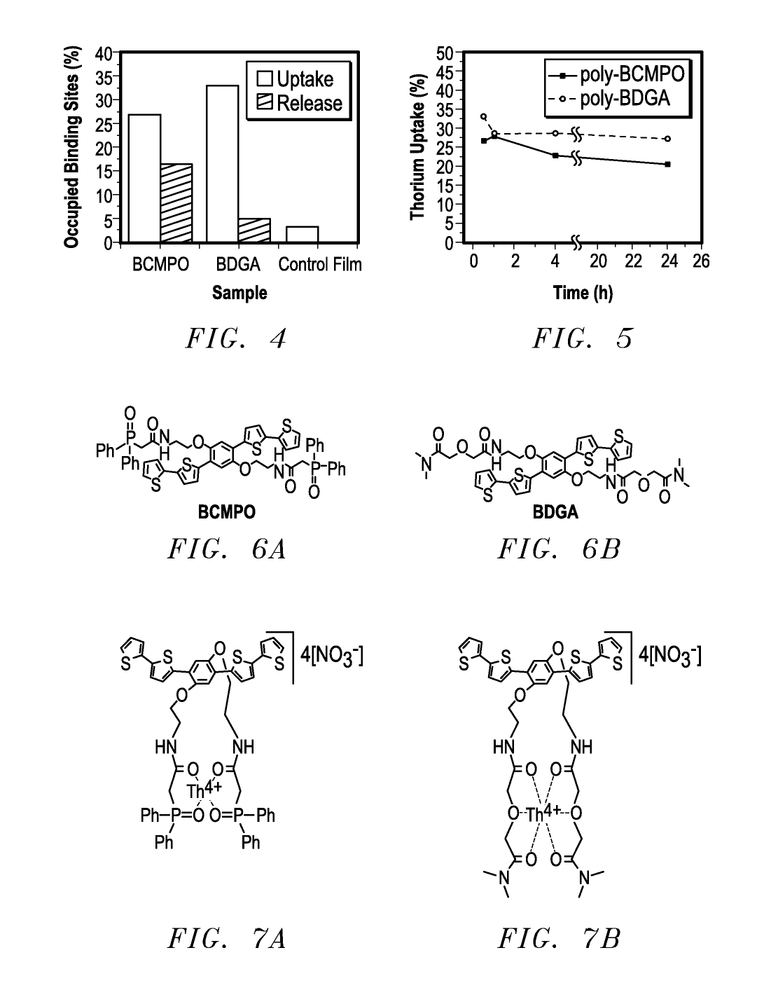

FIG. 4 is a graph that shows the polymer systems can uptake and release ions. Analysis by XPS showed thorium cation uptake into the films as evidence by the thorium 4f peaks at 335 eV and 345 eV and integration of the thorium 4f and sulfur 2p peaks allows for the determination of the percent loading of thorium per monomer unit. The table below shows the extraction and release results.

Extraction Results by XFS Analysis

| | | | Th/Unit | Percent |
|---|---|---|---|---|
| Sample | % S | % Th | [%] | Release |
| poly-BCMPO Loaded | 93.72 | 8.28 | 25.8 | 28.8% |
| poly-BCMPO Released | 96.06 | 3.94 | 18.4 | |
| poly-BDGA Loaded | 92.35 | 7.85 | 33.1 | 84.6% |
| poly-BDGA Released | 98.74 | 1.25 | 5.1 | |
| Control Film Loaded | 99.07 | 0.93 | 3.8 | 100% |
| Control Film Released | 100.00 | 0.00 | 0.0 | |

FIG. 5 is a graph of the uptake of Th(IV) over time. The incubation of the films in a Th(NO₃)₄ showed excellent Th(IV) uptake into the films supporting ionophoric arms while an extremely low uptake was observed for the pure poly-(1,4-bis(bithiophene)benzene) control film.

FIG. 6a is an image of the BCMPO structure. FIG. 6b is an image of the BDGA structure.

FIG. 7a is an image of BCMPO binding Th⁴⁺. FIG. 7b is an image of BDGA binding Th⁴⁺.

FIG. 8a is an image of a homopolymer of BCMPO. FIG. 8b is an image of a homopolymer of BDGA.

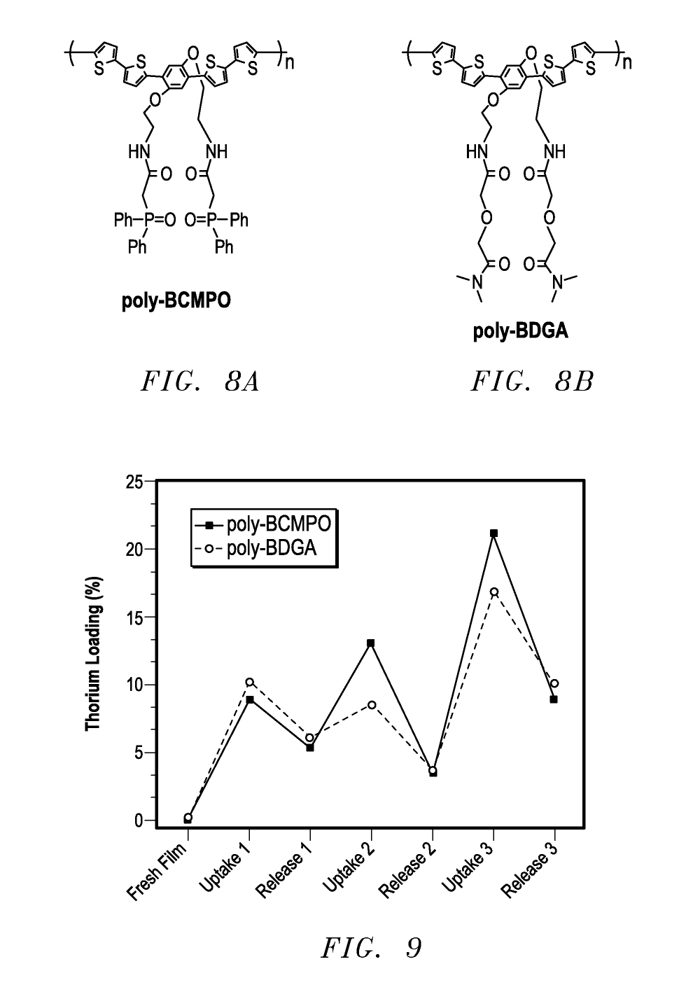

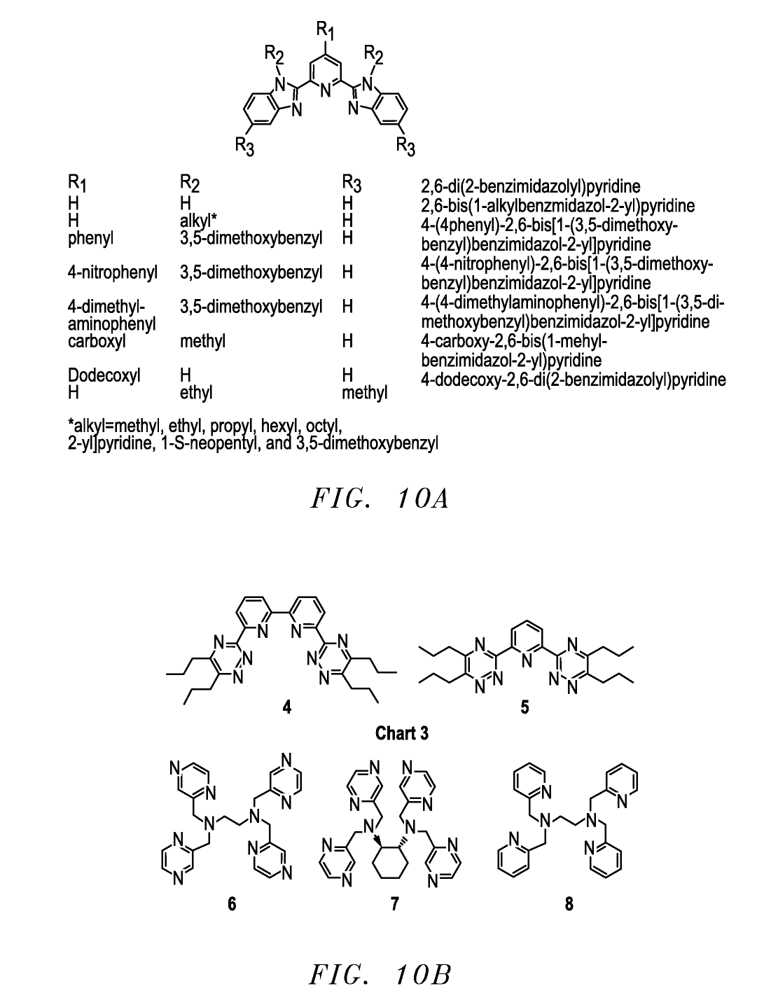

FIG. 9 is a graph of the separation cycle of the conducting polymer film/membrane of the present invention over 3 uptake and release cycles. Cycling of the material shows continued uptake and release through multiple cycles, however the increasing Th(IV) content over time indicates some Th(IV) may be irreversibly bound in the conducting polymer film/membrane.

In addition, it is a well established model that Nd(III) and Sm(III) have been used as surrogate ions for Am(III) and Cm(III), respectively. The incubation of an equimolar solution of Nd(III) and Sm(III) with the conducting polymer film/membrane of the present invention showed selectivity for Nd(III). The poly-BCMPO polymer film bound 98% of the Nd(III) and less than 5% Sm(III) and the poly-DGA polymer film bound 78% of the Nd(III) and about 20% Sm(III). As a result, the conducting polymer film/membrane of the present invention has a selectivity for Am(III).

FIGS. 10a and 10b are images of some of the ligands of the present invention.

The present invention provides a conducting polymer extractant having a polymer backbone made by both chemical and electrochemical polymerization using thiophene and its derivatives, 3,4-ethylenedioxythiophene (EDOT) and its derivatives, those made using terthiophene and its derivatives, those made using aniline and its derivatives, those made using pyrrole and its derivatives, those made using furan and its derivatives, those made using thieno[3,2-b]thiophene and its derivatives, polyphenylene vinylene, polyphenylene, polyphenylene sulfide, polyacetylene, poly(fluorene), polypyrenes, polyazulenes, polynaphthalenes, polycarbazoles, polyindoles, or polyazepines.

The present invention provides numerous combinations of monomers that may be combined to form a polymer. The polymer backbone may be random alternating copolymers in addition to block copolymers. The linker between the polymer backbone and the ligands may be alkyl linkers of different lengths (e.g., 2, 3, 4, 5, 6, 7, 8, 9, 10 or more) or polyethylene glycol linkers of different lengths. The solubilizing groups on the second monomer include single and multiple solubilizing chains, polyethylene glycol chains of different lengths, alkyl chains of various lengths, and perfluoro alkyl chains of various lengths. Examples of ligands that may be attached to the polymer backbone include: 2,4,6-tri(2-pyridyl)-1,3,5-triazine (TPTZ); bis-(2-pyridylmethyl)amine; tris(2-pyridylmethyl)amine; tris(6-methylpyrid-2-yl)amine; 2,2′-Bipyridine; 4′-methylterpyridine; 4′-octylterpyridine; 4′-phosphonatoterpy; 2,2′:6′,2″:6″,2′″-quaterpyridyl; 2,6-di(2-benzimidazolyl)pyridine; 2,6-bis(1,2,4-triazin-3-yl)pyridine; Dimethylthiophosphate (DMTP); 2,6-di(2-pyridyl)pyrimidine; 2-amino-4,6-di(2-pyridyl)-1,3,5-triazine; tris[(6-methyl-2-pyridyl)methyl]amine; tris(2-pyrazylmethyl)amine; N,N′-bis(2-pyridylmethyl)-1,2-ethanediamine; N,N′-bis(2-pyridylmethyl)-1,3-propanediamine; N,N′-bis(2-pyridylmethyl)-1,4-butanediamine; N,N,N′,N′-tetrakis(2-pyridylmethyl)-1,2-ethanediamine; 2,6-di(1,2,4-triazin-3-yl)pyridine; 2,6-bis(5,5,8,8-tetramethyl-5,6,7,8-tetrahydrobenzo-1,2,4-triazin-3-yl)pyridine; 2,6-bis(9,9,10,10-tetramethyl-9,10-dihydrobenzo-1,2,4-triazaanthrane-3-yl)pyridine; 6,6′-bis(1,2,4-triazin-3-yl)-2,2′-bipyridyl; N,N′-dimethyl-N,N′-dioctyl-2-(2-hexoxyethyl)malonamide; 2,6-bis[1-(1-S-neopentyl)benzimidazol-2-yl]pyridine; 4-carboxy-2,6-bis(1-methylbenzimidazol-2-yl)pyridine neopentyl ester; 6,6′-bis(5,6-dialkyl-1,2,4-triazin-3-yl)-2,2′-bipyridines; 6,6′-bis(5,5,8,8-tetramethyl-5,6,7,8 -tetrahydrobenzo-1,2,4-triazin-3-yl)-2,2′-bipyridine; ethylenediaminetetraacetic acid (EDTA); diethylenetriaminepentaacetic acid (DTPA); citrate; humic acid; fulvic acid; nitrilotriacetic acid (NTA); Maltol; Catechol; Hydroxamic acid; 2-Hydroxypyridine-N-oxide (HOPO) and it's derivatives; 2,3-dihydroxyterephthalamide and it's derivatives; sulfonamide catecholates (or SFAM ligands); octyl-(phenyl)-N,N-diisobutyl carbamoyl methyl phosphine oxide (CMPO) (and derivatives); N,N′-dimethyl-N,N′-dibutyl tetradecyl malonamide (DMDBTDMA); N,N′-dimethyl-N,N′-dioctyl-2-(2-hexyloxyethyl)malonamide (DMDOHEMA); diglycolamide and its derivatives; bis(2-ethylhexyl) butyramide; 2,9-bis(1,2,4-triazin-3-yl)-1,10-phenanthroline; dithiophosphinic acid derivatives; cobalt bis(dicarbollide) derivatives; picolineamid derivatives; N,N,N′,N′-Tetraoctyl-3,6-dioxaoctanediamide; N,N-dialkyldiglycolamicacids; 6,6′-bis(aryl)-5,5′-bi-1,2,4-trazines; Cyanex 301; Cyanex 302; Cyanex 272; 2-(Diphenyl-N,N-diethylcarbamoylmethylphosphine oxide)pyridine and its N-oxide; 2-[(Diphenyl-N,N-diethylcarbamoylmethylphosphine oxide)methyl]pyridine and its N-oxide; 2,6-Bis(diphenyl-N,N-diethylcarbamoylmethylphosphine oxide)pyridine and its N-oxide; 2,6-Bis[(diphenyl-N,N-diethylcarbamoylmethylphosphine oxide)methyl]pyridine and its N-oxide; 4-hydroxy-N′N-dialkylbutanamide and its derivatives; 1,2,4-triazine-picolinamide; Picolinamides; 4-amino-2,6-di-2-pyridyl-1,3,5-triazine; or 2,6-bis(benzoxazol-2-yl)-4-dodecyloxypyridine.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A redox mediated polymer composition for the selective sequestration and separation of multivalent metal ions comprising:
2 or more monomers polymerized to form a polymeric thiophene backbone, wherein each of the 2 or more monomers comprise a thiophene portion and one or more pendant carbomylmethylphosphine oxide groups that sequester selectively the multivalent metal ions.

2. The composition of claim 1, further comprising one or more second monomers polymerized with the 2 or more monomers to form a polymeric thiophene backbone, wherein the one or more second monomers comprise one or more pendant diglycolamide (DGA) groups.

3. The composition of claim 1, wherein the multivalent metal ions are selected from Am³⁺, Cu³⁺, Nd³⁺, Sm³⁺ and Th⁴⁺.

4. The composition of claim 1, wherein the redox mediated polymer is disposed on a porous inert resin or silica support.

5. The composition of claim 1, wherein the redox mediated polymer is disposed on a removable electrode.

6. The composition of claim 1, wherein the polymeric thiophene backbone comprises one or more thiophene groups.

7. The method of claim 1, wherein the 2 or more monomers comprise 2 pendant carbomylmethylphosphine oxide groups.

8. The method of claim 2, wherein the one or more second monomers comprise 2 pendant diglycolamide (DGA) groups.

9. The composition of claim 1, wherein the multivalent metal ions is releasably held by the one or more pendant carbomylmethylphosphine oxide groups.

10. A process for selective separating multivalent metal ions in the processing of a nuclear fuel comprising the steps of:
providing a fluid mixture comprising fission products, lanthanides, actinides, nitric acid and water;
providing a redox mediated polymer film for selective sequestration and separation of multivalent metal ions comprising: a polymeric thiophene backbone with one or more pendant carbomylmethylphosphine oxide groups;
contacting the fluid mixture with the redox mediated polymer film;
reversibly binding a multivalent metal ion to the one or more pendant carbomylmethylphosphine oxide groups of the redox mediated polymer film; and
separating the redox mediated polymer film from the fluid mixture, wherein a multivalent metal ion is separated from the fluid mixture.

11. The method of claim 10, further comprising the step of reducing the redox mediated polymer film to release the multivalent metal ion and recycle the redox mediated polymer film.

12. The method of claim 10, further comprising one or more pendant diglycolamide (DGA) groups pendent from the polymeric thiophene backbone.

13. The method of claim 10, wherein the multivalent metal ions are selected from Am³⁺ and Nd³⁺.

14. A process for making a redox mediated polymer composition for the selective sequestration and separation of multivalent metal ions used in the processing of a nuclear fuel comprising the steps of:
providing a CMPO monomer comprising a polymerizable thiophene portion and one or more pendant carbomylmethylphosphine oxide groups;
optionally providing a DGA monomer comprising a polymerizable thiophene portion and one or more pendant diglycolamide (DGA) groups;
polymerizing the polymerizable thiophene portions to form a redox mediated polymer backbone with pendent carbomylmethylphosphine oxide groups to selectively sequester multivalent metal ions; and
optionally diglycolamide (DGA) groups pendent from the redox mediated polymer backbone.

15. The method of claim 14, further comprising the step of forming the redox mediated polymer film into a redox mediated polymer membrane.

16. The method of claim 14, wherein the CMPO monomer comprises 2 pendant carbomylmethylphosphine oxide groups and the DGA monomer comprises 2 pendant diglycolamide (DGA) groups.

17. A redox mediated polymer composition for the selective sequestration and separation of multivalent metal ions comprising:
2 or more monomers polymerized to form a polymeric thiophene backbone, wherein each of the 2 or more monomers comprise
a first monomer that comprises 2 thiophene portions that polymerize to form a polythiophene backbone and 2 pendant carbomylmethylphosphine oxide groups that pend from the polythiophene backbone to sequester selectively the multivalent metal ions; and
optionally a second monomer that comprises 2 thiophene portions that polymerize to form a polythiophene backbone and 2 pendant diglycolamide groups that pend from the polythiophene backbone.

18. The composition of claim 17, wherein the redox mediated polymer composition is a homopolymer of first monomer.

19. The composition of claim 17, wherein the redox mediated polymer composition is a copolymer of first monomer and the second monomer.

20. The composition of claim 17, wherein the copolymer is a block copolymer, a random copolymer or a random block copolymer.

21. A redox mediated polymer composition for selective sequestration of ions having the structure: 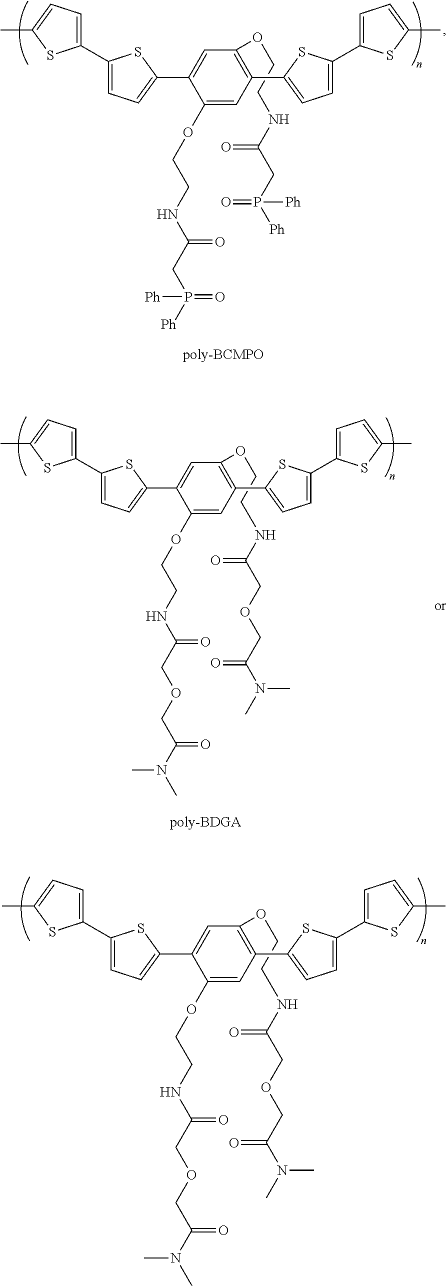 [chemical structure]
